(19) United States
(12) Patent Application Publication
(10) Pub. No.: US 2016/0248084 A1
(43) Pub. Date: Aug. 25, 2016

(54) DURABLE CARBON-COATED LI2S CORE-SHELL MATERIALS FOR HIGH PERFORMANCE LITHIUM/SULFUR CELLS

(71) Applicants: Elton J. Cairns, Walnut Creek, CA (US); Caiyun Nan, Albany, CA (US); Min-Kyu Song, Emeryville, CA (US); Zhan Lin, Albany, CA (US)

(72) Inventors: Elton J. Cairns, Walnut Creek, CA (US); Caiyun Nan, Albany, CA (US); Min-Kyu Song, Emeryville, CA (US); Zhan Lin, Albany, CA (US)

(73) Assignee: THE REGENTS OF THE UNIVERSITY OF CALIFORNIA, Oakland, CA (US)

(21) Appl. No.: 14/630,406

(22) Filed: Feb. 24, 2015

(51) Int. Cl. H01M 4/36; C01B 17/40; H01M 4/587; C01B 17/24; H01M 10/052; H01M 4/58

(52) U.S. Cl. CPC H01M 4/366; H01M 10/052; H01M 4/5815; H01M 4/587; C01B 17/24; C01B 17/40; C01P 2004/32; C01P 2004/62; C01P 2006/40

(57) ABSTRACT

The disclosure provides methods for producing uniformly sized lithium sulfide materials which are coated with one or more durable and conductive carbon shells that impede the polysulfide shuttle. The disclosure further provides for the carbon coated lithium sulfide materials made therefrom, and the use of these materials in lithium sulfide batteries.

### STATEMENT OF GOVERNMENT SUPPORT

The invention described and claimed herein was made in part utilizing funds supplied by the U.S. Department of Energy under Contract No. DE-ACO2-05CH11231 between the U.S. Department of Energy and the Regents of the University of California for the management and operation of the Lawrence Berkeley National Laboratory. The government has certain rights in this invention.

### CROSS REFERENCE TO RELATED APPLICATIONS

Not Applicable

### TECHNICAL FIELD

The disclosure provides methods for producing uniformly sized lithium sulfide materials which are coated with one or more durable and conductive carbon shells that impede the polysulfide shuttle. The disclosure further provides for the carbon coated lithium sulfide materials made therefrom, and the use of these materials in lithium sulfide batteries.

### BACKGROUND

Lithium sulfide (Li₂S) is an attractive cathode material with a high theoretical specific capacity (1166 mAh g-1). However, the poor cycle life and rate capability have remained significant challenges, preventing its practical application.

### SUMMARY

Disclosed herein are methods to synthesize Li₂S materials. Based upon the reaction conditions, the resulting size of the Li₂S materials can be controlled. Further disclosed herein, are methods (e.g., a chemical vapor deposition (CVD)) for carbon-coating the Li₂S materials with a stable, durable conductive carbon layer to form carbon-coated Li₂S materials (Li₂S@C). The Li₂S@C materials of the disclosure provided specific capacities and cycling performance with a high initial discharge capacity of at least 972 mAh g⁻¹ Li₂S (1394 mAh g⁻¹S) at a 0.2C rate. Further, electrodes composed of 98 wt % of 1 μm Li₂S@C material and 2 wt % binder, demonstrated stable cycling performance with little morphology change after 400 cycles at a 0.5C rate.

In a particular embodiment, the disclosure provides a method to synthesize a Li₂S core material having a uniform size, comprising: adding a first solution comprising elemental sulfur in a nonpolar organic solvent to a second solution comprising a strong lithium based reducing agent to make a reaction mixture; and precipitating the Li₂S core material from the reaction mixture by heating the reaction mixture at an elevated temperature (e.g., about 90° C.) for 2 to 30 minutes (e.g., 7 minutes or 10 minutes). In a further embodiment, the method further comprises: collecting the precipitated Li₂S core material from the reaction mixture; washing the Li₂S core material; and drying the Li₂S core material.

In another embodiment, the disclosure provides methods to synthesize a Li₂S core material comprising using a nonpolar organic solvent selected from pentane, cyclopentane, hexane, cyclohexane, benzene, toluene, chloroform, 1,4-dioxane and diethyl ether. In yet another embodiment, the disclosure provides methods to synthesize a Li₂S core material comprising using a strong lithium based reducing agent is selected from lithium triethylborohydride, n-butyl-lithium, and lithium aluminum hydride. In a further embodiment, the disclosure provides methods to synthesize a Li₂S core material comprising using 1.0 M lithium triethylborohydride in 4.2 mL of tetrahydrofuran. In yet a further embodiment, the disclosure provides methods to synthesize a Li₂S core material comprising dissolving 64 mg of sulfur in 6 mL of the nonpolar organic solvent, and further adding a portion of this solution (e.g., 3 mL, 3.5 mL, or 6 mL) to a solution comprising a strong lithium based reducing agent.

In another embodiment, the disclosure provides that the Li₂S core material is substantially spherical in shape. In yet another embodiment, the Li₂S core material is uniformly size particles from 500 nm to 2 μm in diameter (e.g., 1 μm in diameter).

In a particular embodiment, the disclosure provides for uniformly sized Li₂S core material core material made by the methods disclosed herein.

In a further embodiment, the disclosure also provides a method for coating a Li₂S core material core material with one or more durable and conductive carbon shells comprising: placing the uniformly sized Li₂S core material under an atmosphere comprising a carbon based precursor compound and an inert gas; and pyrolyzing the precursor compound by heating at an elevated temperature for a period between 15 minutes to 3 hours. In a further embodiment, the carbon based precursor compound is selected from methane, ethylene, acetylene, benzene, xylene, carbon monoxide, or combinations thereof. In yet a further embodiment, the inert gas is argon. In another embodiment, the inert gas to the carbon based precursor compound is introduced at a Standard Cubic Centimeters per Minute (SCCM) flow rate ratio of 1:10 to 10:1. In yet another embodiment, the carbon based precursor compound is pyrolyzed by heating at a temperature between 400° C. to 700° C. In a particular embodiment, the carbon based precursor compound is pyrolyzed by heating at 450° C. for 1.5 hours.

In a certain embodiment, the disclosure provides for a Li₂S core material comprising one or more carbon shells (Li₂S@C material) made by any one of the methods disclosed herein. In a further embodiment, an electrode comprises the Li₂S@C material disclosed herein. In yet a further embodiment, a lithium/sulfur battery comprises an electrode which comprises a Li₂S@C material of the disclosure.

### DESCRIPTION OF DRAWINGS

FIG. 1A-B provides SEM images of the Li₂S spheres synthesized under different conditions. (A) Synthesis of Li₂S with toluene, but no heat treatment; and (B) Synthesis of Li₂S without toluene.

FIG. 2A-F provides scanning electron microscope (SEM) images of the Li₂S spheres before and after CVD coating. (A) 2 μm Li₂S; (B) 1 μm Li₂S; (C) 500 nm Li₂S; (D) 2 μm Li₂S@C; (E) 1 μm Li₂S@C; and (F) 500 nm Li₂S@C.

FIG. 3A-D provides X-ray diffraction (XRD) and Raman characterization of as-synthesized Li₂S spheres. (A) XRD patterns and (B) Raman spectrum of Li₂S spheres, Li₂S spheres treated at 500° C. and Li₂S@C by further coated Li₂S-500° C. sample with 10 wt % carbon from CVD method; (C) Magnification of the Raman spectrum between 300 cm⁻¹ and 450 cm⁻¹. (D) Schematic of the coating process for the Li₂S@C spheres.

FIG. 4A-B presents electron energy loss spectroscopy (EELS) characterization of the Li₂S@C sphere. (A) STEM image of a Li₂S@C sphere and (B) normalized EELS intensity along the line in (A).

FIG. 5 provides SEM images of Li₂S@C spheres after a polysulfide dissolution test.

FIG. 6A-B presents cycle performance and cyclic voltammogram of the Li₂S@C materials having different sizes. (A) Cycle performances of the 2 μm, 1 μm and 500 nm Li₂S@C particles at 0.5C rates. (B) Cyclic voltammograms of the as-prepared Li₂S@C cathodes at a scan rate of 0.025 mV/s. (Electrode composition: Li₂S@C:C:PVP=66.7:28.3:5 by weight; 60 wt % Li₂S, 1.0-1.5 mg Li₂S/cm²)

FIG. 7A-B provides SEM images and characterization of commercial Li₂S. (A) SEM image of commercial Li₂S; and (B) its cycling performance at the 0.5C rate. (Electrode composition: Li₂S:C:PVP=60:35:5 by weight; 1.2 mg Li₂S/cm²).

FIG. 8 provides a curve of the current versus potential voltage of commercial Li₂S (c-Li₂S) materials before and after ball-milling at a scan rate of 0.025 mV/s. (Electrode composition: Li₂S:C:PVP=60:35:5 by weight; 1.0-1.5 mg Li₂S/cm²).

FIG. 9A-C presents the electrochemical performance of the 1 μm Li₂S@C spheres at different C-rates. (A) Cycling performances and coulombic efficiency of the 1 μm Li₂S @C cathodes at 0.2C, 0.5C and 1C rates. (B) Rate capability of the 1 μm Li₂S@C cathodes. (C) Voltage profile of the 1 μm Li₂S@C spheres at different C-rates. (Electrode composition: Li₂S@C:C:PVP=66.7:28.3:5 by weight; 60 wt % Li₂S, 1.0-1.5 mg Li₂S/cm²)

FIG. 10A-B provides cycling performance of a Li₂S@C-based electrode and SEM images of the electrode. (A) Cycling performance of the 1 μm Li₂S @C electrode with no added carbon and 98 wt % Li₂S@C spheres at 0.5C. (B) SEM images of the electrode after 400 cycles. (Electrode composition: Li₂S@C:SBR=98:2 by weight; 88 wt % Li₂S, 1.1 mg Li₂S/cm²)

### DETAILED DESCRIPTION

As used herein and in the appended claims, the singular forms “a,” “and,” and “the” include plural referents unless the context clearly dictates otherwise. Thus, for example, reference to “a Li₂S material” includes a plurality of such materials and reference to “the carbon coating” includes reference to one or more carbon coatings and equivalents thereof known to those skilled in the art, and so forth.

Unless defined otherwise, all technical and scientific terms used herein have the same meaning as commonly understood to one of ordinary skill in the art. Although many methods and reagents similar or equivalent to those described herein, the exemplary methods and materials are presented herein.

As current cathode materials for lithium ion cells approach an intrinsic specific capacity limit of less than 300 mAh g⁻¹, new generations of rechargeable cathodes with high capability are needed. Sulfur is a promising candidate which has a high theoretical specific capacity of 1675 mAh g⁻¹ as well as being low cost, abundant and environmentally benign. Significant progress has been made to improve the utilization of sulfur and alleviate the capacity fading by size control of the sulfur particles, coatings on sulfur particles, use of sulfur-carbon composites, trapping of polysulfides and electrolyte modification. However, for use with the sulfur cathode, lithium metal or a light-weight lithiated anode is important for high specific energy. Lithium metal typically forms dendrites in conventional organic solvent-based electrolytes, causing safety concerns. Furthermore, some of the protective coatings on sulfur particles may be easily destroyed because sulfur undergoes a volume expansion of ˜76% when totally converted to Li₂S.

Considering the challenges for the sulfur cathode, fully lithiated sulfur, lithium sulfide (Li₂S), is an attractive cathode material for lithium/sulfur (Li/S) cells, with a theoretical specific capacity of 1166 mAh g⁻¹. It can be paired with different kinds of lithium metal free materials, such as the high capacity silicon anode. Moreover, compared with sulfur, Li₂S has a higher melting point and is in the maximum volume state, so modifications on Li₂S materials can be performed at a higher temperature and the surface coating can be more stable. Nevertheless, the problems of low electronic conductivity, and the solubility of polysulfides in many electrolytes still exist for Li₂S cathodes. Thus, the use carbon-containing composites, controlling particle size and providing protection for the Li₂S active materials are important considerations to be taken into account. A protective and conductive shell on the surface of small Li₂S particles, which is not broken by expansion during discharge, provides tangible advantages for the Li₂S materials disclosed herein in Li/S cells. Commercial Li₂S powder or commercial Li₂S is subjected to ball-milling, and because of which, the particle size and morphology are random and may not be at an ideal configuration for surface modifications.

Any number of methods known in the art may be used to produce the Li₂S core material disclosure herein. In a particular embodiment, a Li₂S core material of the disclosure can be prepared by a solution-based reaction of elemental sulfur with a strong lithium based reducing agent such as, superhydride (i.e., Li(CH₂CH₃)₃BH), n-butyl-lithium, or lithium aluminum hydride, in any number of different weak acids (e.g., formic acid, acetic acid, and nitrous acid) and collecting the precipitate. In a preferred embodiment, the strong lithium based reducing agent is Li(CH₂CH₃)₃)BH. In a certain embodiment, a method of synthesizing a Li₂S material comprises: dissolving elemental sulfur in a nonpolar organic solvent (e.g., toluene) to form a sulfur containing solution; adding the sulfur containing solution to a solution comprising a strong lithium based reducing agent so as to form a reaction mixture; and precipitating the Li₂S materials from the reaction mixture by heating the mixture at an elevated temperature (e.g., 90° C.) for 2-30 minutes. In a particular embodiment, the reaction is heated at 90° C. for up to 2 minutes, for up to 3 minutes, for up to 4 minutes, for up to 5 minutes, for up to 6 minutes, for up to 7 minutes, for up to 8 minutes, for up to 9 minutes, for up to 10 minutes, for up to 11 minutes, for up to 12 minutes, for up to 13 minutes, for up to 14 minutes or for up to 15 minutes. In another embodiment, the nonpolar organic solvent is selected from pentane, cyclopentane, hexane, cyclohexane, benzene, toluene, chloroform, 1,4-dioxane and diethyl ether. In a preferred embodiment, the nonpolar organic solvent is toluene. In a further embodiment, the method further comprises collecting the precipitated Li₂S core material and washing the precipitated Li₂S core material.

In another embodiment, the chemical reaction for the synthesis of Li₂S is indicated below.

S+2LiEt₃BH=Li₂S+2Et₃B+H₂

Sulfur was first dissolved in toluene and then added into a solution of lithium triethylborohydride (LiEt₃BH) in tetrahydrofuran (THF). After the THF was removed by heat treatment, stable Li₂S spheres were formed. For example, the S-toluene solution was then added to 1.0 M lithium triethylborohydride in tetrahydrofuran (4.2 mL). After stirring for 2 min at ambient temperature, the solution was heated to 90° C. for 10 minutes under continuous stirring.

When synthesizing these Li₂S spheres, both the heat treatment and the use of toluene played very important roles. The particles assume a spherical shape due to the combination of small droplet size of the liquid dispersion, the elevated temperature, and the limited solubility of Li₂S. We have observed that, without the elevated temperature, spherical particles are not formed. Toluene dissolves S and thus a liquid droplet dispersion is formed. According to our observations, THF has a higher solubility for Li₂S than does toluene, so when the heat treatment is applied, the THF slowly evaporates and stable Li₂S spheres are formed in toluene. The sizes of the Li₂S spheres were related to the amount of toluene used in the preparation. With the same amount of dissolved S (2 mmol), the largest amount of toluene (6 mL) gives the largest spherical Li₂S size of 2 μm, while the 3.5 and 3 mL toluene amounts form 1 μm and 500 nm Li₂S spheres respectively. When the obtained Li₂S spheres are further converted to Li₂S@C particles by CVD coating, volume shrinkage and roughening of the surface can be observed for these Li₂S spheres, as shown in FIG. 2d-f. For the 2 and 1 μm Li₂S spheres, their morphologies do not change much after carbon coating. But for the 500 nm Li₂S spheres, many Li₂S particles are obviously linked together, showing some agglomeration after heat treatment.

The syntheses methods disclosed herein may be modified to produce particles having different sizes by adjusting the reaction times and/or increasing or decreasing the amount of sulfur added to the reaction mixture. For example, small size particles can be generated by using shorter reaction times and decreasing the amount of sulfur added to the reaction mixture; and vice versa, larger particles can be generated by using longer reaction times, and increasing the amount of sulfur added to the reaction mixture. In a certain embodiment, the disclosure provides one or more methods to synthesize the Li₂S core material having a uniform particulate size. In a further embodiment, the Li₂S core material is substantially spherical and/or substantially ovoid in shape. In another embodiment, the synthesis methods disclosed herein can generate uniformly size Li₂S particles from 250 nm to 3 μm, from 500 nm to 2 μm, from 1 μm to 2 μm in size. In yet another embodiment, the synthesis methods disclosed herein can generate uniformly size Li₂S particles greater than 500 nm, greater than 600 nm, greater than 700 nm, greater than 800 nm, greater than 900 nm, greater than 1 μm, greater than 1.2 μm, greater than 1.4 μm, greater than 1.6 μm, greater than 1.8 μm, greater than 2 μm, greater than 2.2 μm, greater than 2.4 μm, greater than 2.6 μm, or greater than 2.8 μm in size. In a further embodiment, the synthesis methods disclosed herein can generate uniformly size Li₂S particles that are 200 nm, 300 nm, 400 nm, 500 nm, 600 nm 700 nm, 800 nm, 900 nm, 1 μm, 1.1 μm, 1.2 μm, 1.3 μm, 1.4 μm, 1.5 μm, 1.6 μm, 1.7 μm, 1.8 μm, 1.9 μm, 2.0 μm, 2.1 μm, 2.2 μm, 2.3 μm, 2.4 μm, 2.5 μm, 2.6 μm, 2.7 μm, 2.8 μm, 2.9 μm, or 3.0 μm in size.

The disclosure further provides that the Li₂S core material may be coated with one or more shells of carbon. In a particular embodiment, the carbon shells increase the conductivity of the Li₂S core material in comparison to Li₂S core material alone. The carbon coating may be applied so that the coating uniformly coats the Li₂S core material or alternatively the coating is applied so that the coating does not uniformly coat the Li₂S core material (i.e., portions in which the carbon shells are thicker and portions in which the carbon shells are thinner). Alternatively, the carbon shells can be patterned on the Li₂S core material, such as by using lithography based methods. In a further embodiment, the carbon shell material is selected from carbon black, acetylene black carbon, pyrolytic carbon, pyrolytic graphene, or polyaniline polysulfide (SPan).

The term “carbon based precursor compound” as used herein refers to a saturated or unsaturated C₁ to C₂₀ compound that may be optionally substituted.

A carbon shell can be applied to the Li₂S core material by using various techniques. For example, in one embodiment, a carbon-based coating can be applied to the Li₂S core material by using a chemical vapor deposition process. In an alternate embodiment, a carbon-based coating can be applied to the Li₂S core material by using a carbonization process. For example, Li₂S core material can be carbon coated by preparing a mixture comprising a conductive carbon-based polymer, applying the mixture to the Li₂S core material, and then carbonizing the carbon-based polymer by pyrolysis. The pyrolysis of the carbon based precursor compound is typically carried out in a non-oxygen environment and typically under a stream of inert gas such as, for example, Argon.

Accordingly, in a certain embodiment, a carbonization process is used to coat carbon on the Li₂S core material by pyrolyzing a carbon based precursor compound. During the pyrolysis step, chemical and physical rearrangements occur, often with the emission of residual solvent and byproduct species, which can then be removed. As used in the disclosure, the term “carbon coating by carbonization” means that the carbon coating is generated from pyrolysis of a suitable carbon based precursor compound to amorphous pyrolytic carbon or pyrolytic graphene. A suitable precursor carbon compound (e.g., carbon based polymer) can be applied to the Li₂S core material by any number of methods known in the art. For example, the Li₂S core material can be immersed or soaked in a mixture, solution, or suspension comprising the carbon based precursor compound. Alternatively, a mixture, solution, or suspension comprising the carbon based precursor compound can be applied to the Li₂S core material by spraying, dispensing, spin coating, depositing, printing, etc. The carbon based precursor compound can then be carbonized by heating the precursor compound at a suitable temperature and for a suitable time period so that the carbon based precursor compound undergoes thermal decomposition to carbon.

A carbon based first coating produced by carbonization can result from pyrolyzing a carbon based precursor compound at temperatures of about 300 to 800° C. in a reaction vessel, for example a crucible. Typically, pyrolyzation of the carbon based precursor compound is conducted at a temperature of at least 200° C. and up to 700° C. for a time period of up to 48 hours, wherein, generally, higher temperatures require shorter processing times to achieve the same effect. In a certain embodiment, carbonization of the carbon based precursor compound is conducted by pyrolyzing the at a temperature of at least 425° C. and up to 600° C. for a time period of up to 48 hours. In different embodiments, the temperature employed in the pyrolysis step is 200° C., 250° C., 300° C., 350° C., 400° C., 450° C., 500° C., 550° C., 600° C., 650° C., or 700° C., or within a temperature range bounded by any two of the foregoing exemplary values. For any of these temperatures, or a range therein, the processing time (i.e., time the carbon based precursor compound is processed at a temperature or within a temperature range) can be, for example, precisely, at least, or no more than 15 minutes, 30 minutes, 1 hour, 2 hours, 3 hours, 4 hours, 5 hours, 6 hours, 12 hours, 18 hours, 24 hours, 30 hours, 36 hours, 42 hours, 48 hours, or within a time range bounded by any two of the foregoing exemplary values. Carbonization to produce carbon shells may include multiple, repeated steps of pyrolysis with the carbon based precursor compound. Between each step, aggregates can be milled to substantial homogeneity, followed by further pyrolysis with additional carbon based precursor compound. The thickness of the carbon shells can be modulated by any number of means, including (i) using repeated pyrolysis steps with carbon based precursor compound, (ii) increasing the amount of carbon based precursor applied to the Li₂S core material, and (iii) the type of carbon based precursor compound. The amount of carbon deposited as a carbon shell may be determined by a measuring a change in weight before and after applying the coating to the Li₂S core material.

Typical carbon based precursor compounds that can be used in the carbonization methods disclosed herein, includes carbon based polymers. For example, inexpensive carbon based polymers such as polystyrene (PS), polyacrylonitrile (PAN), and polymetylmetacrylate (PMMA) can be used. Carbon based polymers, unlike explosive gaseous raw carbon sources, are safe to handle and relatively inexpensive.

In a further embodiment, the pyrolysis step described above can be followed by a higher temperature sintering step to further encourage formation of a graphene product. In some embodiments, the sintering step is employed primarily to induce further crystallization, particularly when the product resulting from pyrolysis is found to retain an amorphous portion. Typically, the sintering step is conducted at a temperature greater than 700° C. and up to 1350° C. for a time of up to 48 hours, wherein, generally, higher temperatures require shorter processing times to achieve the same effect. In different embodiments, the temperature employed in the sintering step is up to 750° C., up to 800° C., up to 850° C., up to 900° C., up to 950° C., up to 1000° C., up to 1050° C., up to 1100° C., up to 1150° C., up to 1200° C., up to 1250° C., up to 1300° C., or up to 1350° C., or within a temperature range bounded by any two of the foregoing exemplary values. For any of these temperatures, or a range therein, the processing time can be, for example, any of the exemplary processing times or time ranges provided herein.

In a preferred embodiment, carbon shells can be produced by using a chemical vapor deposition (CVD) process. CVD is a chemical process used to produce high-purity, high-performance solid materials. For the Li₂S@C materials disclosed herein, a carbon coating can be deposited onto a Li₂S core material by placing the Li₂S core material under an atmosphere comprising a carbon based precursor compound, such as acetylene, and heating at a temperature so as to pyrolyze the precursor compound. In a certain embodiment, the temperature employed in the CVD step is up to 400° C., up to 450° C., up to 500° C., up to 550° C., up to 600° C., up to 650° C., or up to 700° C., or within a temperature range bounded by any two of the foregoing exemplary values. In a further embodiment, the CVD step is performed over a period of 15 minutes, 30 minutes, 1 hour, 1.5 hours, 2 hours, 2.5 hours, 3 hours, or within a temperature range bounded by any two of the foregoing exemplary values. In a particular embodiment, a carbon coating can be deposited onto a Li₂S core material by transferring the Li₂S core material to a glove box and introducing an inert gas and carbon based precursor compound (e.g., a hydrocarbon) at a defined Standard Cubic Centimeters per Minute (SCCM) flow rate. In a further embodiment, the SCCM flow rate of the inert gas to carbon based precursor compound is introduced at a defined ratio. In a particular embodiment, the inert gas to the carbon based precursor compound is introduced at a SCCM flow rate ratio of 1:10 to 10:1, 1:9 to 9:1, 1:8 to 8:1, 1:7 to 7:1, 1:6 to 6:1, 1:5 to 5:1, 1:4 to 4:1, 1:3 to 3:1, or 1:2 to 2:1. For example, in a particular embodiment, Argon is introduced at 100 SCCM while acetylene is introduced at 10 SCCM resulting in a SCCM flow rate ratio of 10:1. In another embodiment, the CVD process utilizes a carbon based precursor compound selected from methane, ethylene, acetylene, benzene, xylene, carbon monoxide, or combinations thereof. Depending on the particular carbon based precursor compound, the flow rates can be adjusted to desired values using a mass flow controller. The thickness of the carbon coating can be modulated by adjusting the length of time the Li₂S core material is exposed to the carbon based precursor compound, changing the flow rate of the carbon based precursor compound, and/or changing the deposition temperature. In order to achieve a more even carbon coating, the Li₂S materials can be periodically removed from heat and milled to break up any agglomerations. The Li₂S materials are then reheated with the carbon based precursor compound. The amount of carbon deposited can be determined by a change in weight of the Li₂S materials.

To compensate for the poor ionic and electronic conductivity for the sulfur containing electrodes, a liquid electrolyte is conventionally employed, which has a high solubility of lithium polysulfides and sulfide. The utilization of sulfur in batteries containing liquid electrolyte depends on the solubility of these sulfur species in the liquid electrolyte. Further, the sulfur in the positive electrode, e.g., cathode, except at the full charge state, is generally present as a solution of polysulfides in the electrolyte. The concentration of polysulfide species Sₙ²⁻ with n greater than 4 at the positive electrode is generally higher than that at the negative electrode, e.g., anode, and the concentration of Sₙ²⁻ with n smaller than 4 is generally higher at the negative electrode than the positive electrode. The concentration gradients of the polysulfide species drive the intrinsic polysulfide shuttle between the electrodes. Polysulfide shuttle transports sulfur species back and forth between the two electrodes, in which the sulfur species may be migrating within the battery all the time. Polysulfide shuttle leads to poor cyclability, high current leakage, and low charge-discharge efficiency. Further, a portion of the polysulfide is transformed into lithium sulfide (Li₂S), which is deposited on the negative electrode. The deposited polysulfide may cause a “chemical short” of the battery. The “chemical short” leads to the loss of active materials, corrosion of the lithium containing negative electrode, i.e., anode, and a low columbic efficiency. Further, the mobile sulfur species causes the redistribution of sulfur in the battery and imposes a poor cycle-life for the battery, in which the poor cycle life directly relates to micro-structural changes of the electrodes. This deposition process occurs in each charge/discharge cycle, and eventually leads to the complete loss of capacity of the sulfur positive electrode. The deposition of lithium sulfide also leads to an increase of internal cell resistance within the battery due to the insulating nature of lithium sulfide. Progressive increases in charging voltage and decreases in discharge voltage are common phenomena in lithium/sulfide (Li/S) batteries, because of the increase of cell resistance in consecutive cycles. Hence, the energy efficiency decreases with the increase of cycle number. It was found that the carbon shells of the Li₂S@C materials disclosed herein were not only durable but inhibited the polysulfide shuttle.

The disclosure further provides that the Li₂S@C materials disclosed herein or the composites made thereof can be used in a variety of applications, including for use in Li/S batteries. In comparison to conventional Li/S cells the Li/S cells comprising the Li₂S@C materials have higher energy densities, lower material costs, and better cycling performance. Accordingly, Li/S cells comprising the Li₂S@C materials could be used in high performance batteries in vehicles, electronic devices, electronic grids and the like. In a particular embodiment, a battery comprises the Li₂S@C materials disclosed herein or the composites made thereof. In a further embodiment, the battery is a rechargeable Li/S battery. In yet a further embodiment, the battery comprising the Li₂S@C materials disclosed herein or the composites made thereof is used in consumer electronics, electric vehicles, or aerospace applications.

The results provided herein demonstrate that the Li₂S @C core-shell particles deliver both high specific capacity and stable cycling performance. The following examples are intended to illustrate but not limit the disclosure. While they are typical of those that might be used, other procedures known to those skilled in the art may alternatively be used.

### Examples

### Materials

Sulfur was purchased from International Sulphur Inc. All other materials were purchased from Sigma-Aldrich Co. All materials were of the highest grade possible.

Synthesis of the Li/S Materials.

As Li₂S is highly sensitive to moisture, all of the synthesis work was carried out in an argon filled glove box with a moisture content below 0.1 ppm and oxygen levels below 5 ppm. The 2 μm Li₂S spheres were prepared as follows: Sulfur (64 mg) was dissolved in toluene (6 mL) under stirring for 5 min at 40° C. to afford an S-toluene solution. The S-toluene solution was then added to 1.0 M lithium triethylborohydride in tetrahydrofuran (4.2 mL). After stirring for 2 min at ambient temperature, the solution was heated to 90° C. for 10 minutes under continuous stirring. The Li₂S precipitate that formed was washed with tetrahydrofuran and hexane. The 1 μm Li₂S and 500 nm-Li₂S spheres were synthesized by the same process except a shorter reaction time of 7 minutes, and a different amount of toluene, 3.5 mL and 3 mL respectively were used. The chemical reaction for the synthesis of Li₂S is indicated in Equation 1:

S+2LiEt₃BH=Li₂S+2Et₃B+H₂ (1)

Carbon Coating the Li/S Materials.

To obtain the Li₂S @C core-shell particles with a 10 wt % carbon coating, the as-prepared Li₂S spheres were heated at 500° C. for 0.5 hours under Argon, and then coated with carbon by a chemical vapor deposition (CVD) method at 450° C. for 1.5 hours, using acetylene and argon gas (100 SCCM (standard cubic centimeters per minute) Ar plus 10 SCCM C₂H₂). In order to obtain a uniform coating, the powder was ground with a mortar and pestle in the glovebox for 10 min after each 30-minutes of CVD coating.

Preparing Electrodes Comprising Li₂S@C Material:

For the 60 wt % Li₂S electrodes: Li₂S@C powder was ground with a mortar and pestle along with carbon black (Super P) and polyvinylpyrrolidone (PVP; M_{w}˜1,300K) in a weight ratio of 66.7:28.3:5 (Li₂S:C:PVP=60:35:5 by weight) for 10 min, and then dispersed in N-methyl-2-pyrrolidinone (NMP) by sonication for 5 minutes and stirring for 4 hours to form a slurry. To make working electrodes, the slurry was drop-cast onto carbon fiber paper (Hesen Electrical Ltd, HCP010N; 0.1 mm thickness, 75% porosity), dried in vacuo, and heated at 60° C. overnight. The mass loading of the electrodes was around 1.0-1.5 mg/cm².

For the 88 wt % Li₂S electrodes: The electrodes were made by dispersing the 1 μm Li₂S@C powder in NMP using 5 minutes sonication and 4 hours stirring, and then drop-casting the slurry onto a carbon paper current collector. In order to avoid powder dropping through the pores of the carbon paper, 20 uL of SBR-Toluene (Li₂S@C:SBR=98:2 w/w) was added to both sides of the carbon paper. Considering the 10 wt % carbon coating on the 1 μm Li₂S@C particles, the total content of Li₂S in the cathodes was around 88 wt %. For the electrolyte, 1M lithium bis(trifluoromethanesulfonyl)imide (LiTFSI) in N-methyl-N-butylpyrrolidinium bis(trifluoromethane sulfonyl)imide (PYR14TFSI)/DOL/DME (2:1:1, by volume) containing 1 wt % LiNO₃ was prepared. CR2032-type coin cells were fabricated with a porous polypropylene separator (2400, Celgard) and a lithium metal foil as counter/reference electrode in an Ar glove box.

Physical Characterization of the Li₂S and Li₂S@C Materials:

X-ray diffraction (XRD) patterns were collected on a Brucker XRD instrument (D2 Phaser) after the samples were protected by a Kapton film (Chemplex Industries, Inc.). Raman spectroscopy (Labram, ISA Groupe Horiba) was performed after the samples were sealed in a chamber with a glass window in a glovebox. The morphology of the samples was detected by a field emission scanning electron microscope (JEOL JSM-7500F). The EELS line scan was conducted by transmission electron microscope (TEM: 200 kV FEI monochromated F20 UT Tecnai) on a lacey silicon monoxide grid under the protection by an argon glove bag for transferring the samples.

Polysulfide Dissolution Test.

The Li₂S and Li₂S @C materials were tested for polysulfide dissolution according to the following: 1 mg Li₂S@C spheres and 7 mg S were mixed in a 1.5 mL THF/toluene (2:1, v/v) solution for two weeks. The resulting precipitate was then washed with THF twice and dried for SEM.

Evaluating the Effect of Heat and Solvents on the Synthesis of the Li/S Materials:

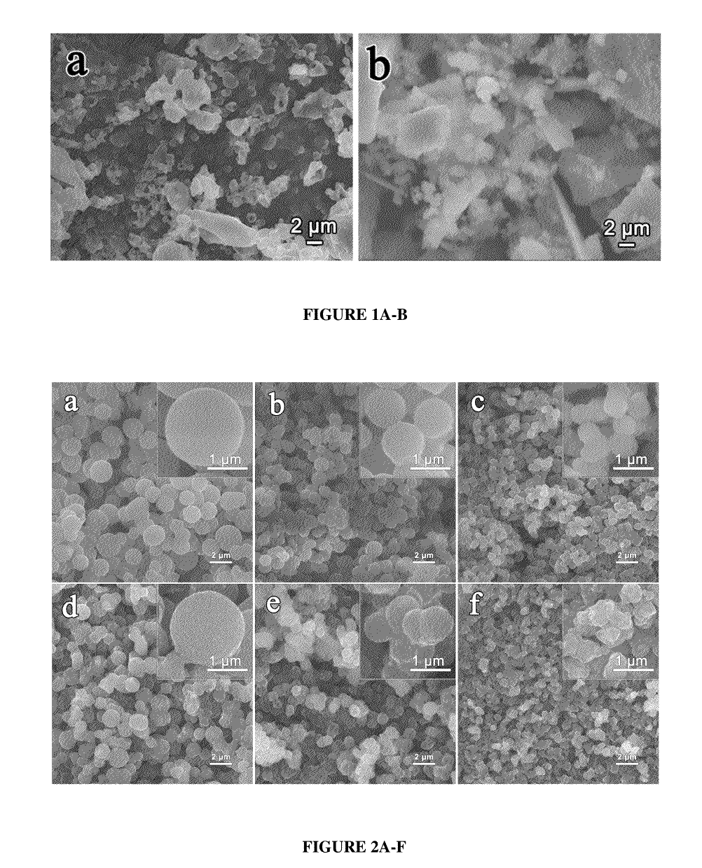

For the synthesis of spherical Li₂S particles, both the heat treatment and toluene played important roles. Without heat treatment, the morphology of the Li₂S particles were not uniform and only a few spherical particles were detected (see FIG. 1A). When the synthesis was performed without toluene, no spherical Li2S particle was formed (see FIG. 1B).

Controlling the Size of the Li/S Materials:

SEM images of the three sizes of Li₂S spheres, with typical sizes of ˜2 μm, 1 μm and 500 nm, and their corresponding Li₂S@C core-shell particles are presented in FIG. 2A-F. When synthesizing these Li₂S spheres, the heat treatment and the use of toluene played very important roles (see FIG. 1B). The heat treatment helps to form uniform Li₂S spheres, and spherically-shaped Li₂S particles can be obtained only when toluene is present. More importantly, the sizes of the Li₂S spheres correlated to the amount of toluene added (see FIG. 2A-2C). With less toluene, the concentration of sulfur was higher, which accelerated the nucleation speed of Li₂S particles and thus resulted in smaller Li₂S spheres. After converting to Li₂S@C spheres by CVD coating, volume shrinkage and roughening of the surface was observed for these Li₂S spheres (see FIG. 2D-2F). For 2 μm and 1 μm Li₂S spheres, their morphologies don't change much. But for 500 nm Li₂S spheres, agglomeration occurred and it was noticeable that many Li₂S particles were linked together.

Physical Characterization of the Li₂S Materials by X-Ray Diffraction (XRD) and Raman Spectroscopy.

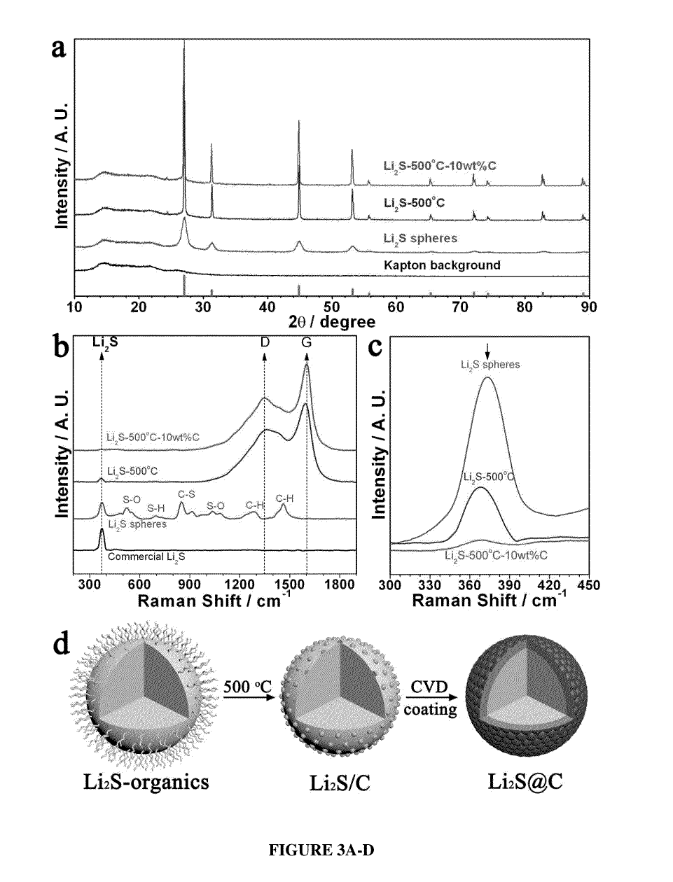

XRD and Raman spectra of the as-prepared Li₂S spheres are shown in FIGS. 3A and 3B. The X-ray diffraction (XRD) spectrum shows that a pure Li₂S powder was formed (JCPDS card no. 23-0369) by the reaction of sulfur with LiEt₃BH. However, in the Raman spectrum, besides showing the characteristic peaks of Li₂S at ˜370 cm⁻¹, several C—H, C—S, S—H and S—O bonds were detected between 700-1500 cm⁻¹, which reflect the existence of an organic residue in the powder. To remove the organics, the as-synthesized white Li₂S spheres were heat treated in an argon atmosphere at 500° C. for 0.5 h (labeled as Li₂S-500° C.). After the heat treatment, the white Li₂S-spheres became a fine grey powder, and the sharp XRD peaks reveal an enhanced crystallization of the Li₂S particles (see FIG. 3A). The Raman spectra show that after heat treatment all the peaks of the organic residue were gone (see FIG. 3B). Instead, new Raman peaks corresponding to the D band and G band of carbon were found. In addition, the intensity of the Li₂S peak was found to be reduced. These spectra indicate that the organic residues were converted to carbon and covered some parts of the Li₂S particles. In order to increase the conductivity of the Li₂S powder as well as protect the Li₂S particles from sulfur (polysulfide) loss during the electrochemical reaction, the Li₂S-500° C. material was further coated with carbon by CVD at 450° C. for 1.5 hours using acetylene gas to form Li₂S-10 wt % C core-shell particles (labeled as Li₂S@C). Compared with the Li₂S-500° C. material, no obvious change was found in the XRD patterns for the Li₂S@C powder. However, the intensity of the Li₂S peak in the Raman spectrum decreased. As shown in FIG. 3C, it's hard to see the Li₂S peak in the Li₂S@C material, which demonstrates that the carbon shell from CVD covered most of the Li₂S-core and blocked the Raman signal of Li₂S. The steps in the procedure for preparing the Li₂S@C core-shell particles are summarized in FIG. 3D.

Confirming the Li₂S-Core Carbon-Shell Structure by Electron Energy Loss Spectroscopy.

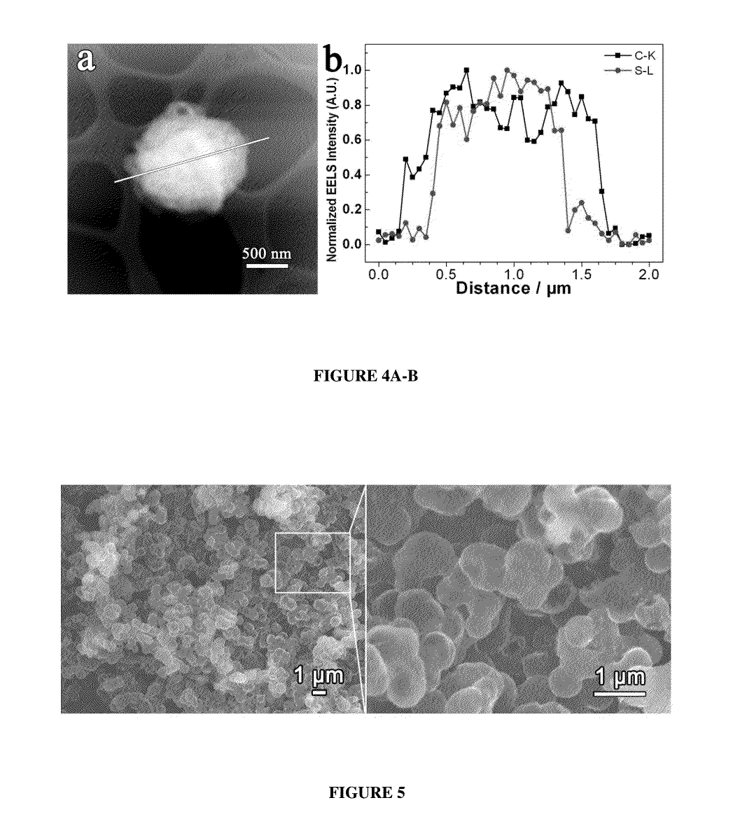

To further confirm the core-shell structure of the Li₂S@C spheres, an electron energy loss spectroscopy (EELS) line scan across a typical Li₂S@C sphere was performed, and the normalized EELS intensities of its S-L and C-K peaks were analyzed (see FIG. 4). The results illustrate the Li₂S@C sphere to be a typical core-shell structure, in which carbon covers the surface of the Li₂S sphere. The stable core-shell structure was also demonstrated by a polysulfide dissolution test on a large number of Li₂S@C spheres (see FIG. 5). These observations support the conclusion that the CVD process effectively coats carbon on the Li₂S spheres so as to form carbon-coated Li₂S core-shell spheres.

Evaluating Polysulfide Dissolution of Li₂S and Li₂S@C Materials.

After the polysulfide dissolution test, unprotected Li₂S spheres reacted with sulfur and were washed away by THF in the form of polysulfide. Therefore, the precipitate left would be comprised only of well protected Li₂S@C spheres and broken carbon shells. The ratio of unreacted Li₂S@C spheres would indicate the effects of the protection of the carbon-shells on Li₂S@C spheres, and the broken carbon shells would give a direct idea of how the carbon-shells look. As shown in FIG. 5, most spherical Li₂S@C particles remained undamaged after the polysulfide dissolution test and only a few particles changed to hollow spherical structures, which shows that the as-prepared Li₂S@C spheres had a stable core-shell configuration and most Li₂S particles were well protected by the carbon-shells.

Electrode and Electrochemical Performance of Different Sized Li₂S@C Materials.

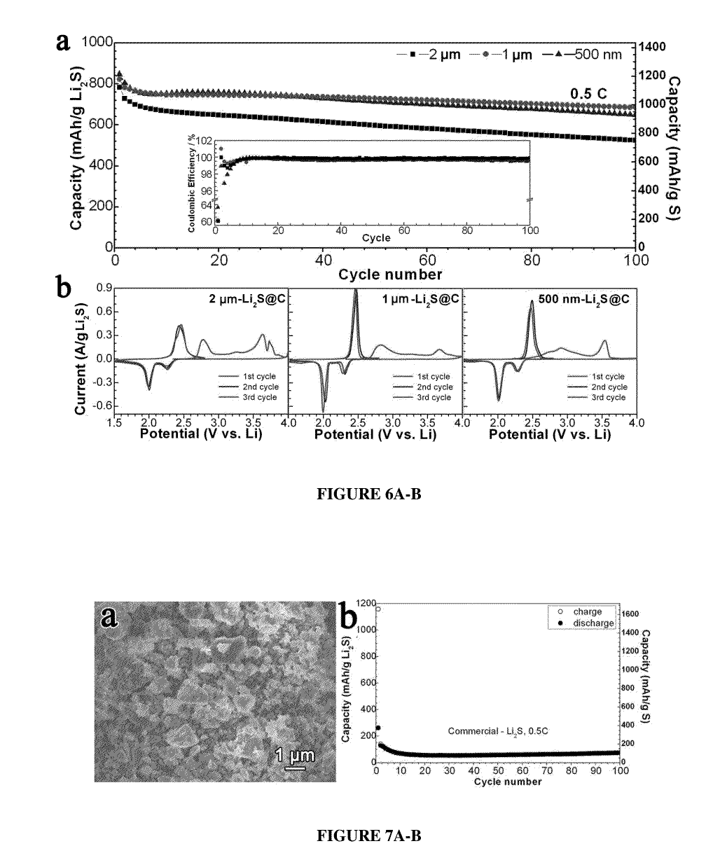

In coin cells under the same conditions, the effects of particle size on electrode performance were evaluated, along with the electrochemical performance of three Li₂S@C materials. FIG. 6A shows the discharge capacities of the 2 μm, 1 μm, and 500 nm Li₂S@C spheres at the 0.5C rate (1C=1166 mA g⁻¹ Li₂S). All of the electrodes were first charged to 4.0 V at the 0.05C rate to activate the cathodes and then cycled between 1.5 V and 2.8 V at the 0.5C rate. All cells show a high coulombic efficiency resulting from the small and uniform particle sizes as well as the protection provided by the stable carbon-shell of these Li₂S@C spheres (Cycle performance of commercial Li₂S powder under the same conditions is shown in FIG. 7B). Among these three synthesized Li₂S@C materials, the electrochemical utilization of the 2 μm Li₂S is the lowest, which gives the lowest specific capacity. The 500 nm Li₂S@C and 1 μm Li₂S@C electrodes show very similar performance during the first 30 cycles. However, the 500 nm Li₂S@C spheres show a higher capacity fade rate than the 1 μm Li₂S@C after 100 cycles. This may be caused by the change of morphology of the Li₂S@C particles after heat treatment and CVD coating at high temperature. The 500 nm-Li₂S@C particles undergo a more serious agglomeration as a result of heat treatment as shown in FIG. 2F.

In order to analyze the effect of agglomeration of Li₂S particles, the cyclic voltammetry (CV) curves of the three Li₂S@C cathodes were compared as shown in FIG. 6B. As for the commercial Li₂S, the pristine particles with large particle sizes usually exhibit initial charge peaks at high voltages and after being ball-milled the charge peaks shift to a lower voltage because of reduced particle size (See FIG. 8). By comparing the initial charge peaks of the three sizes of synthesized Li₂S@C particles, it is possible to see the effect of the size changes resulting from agglomeration. For the as-synthesized 2 μm Li₂S@C material, there are three peaks in the first charge curve. In addition to the one charge peak below 3.5 V, there are two other peaks above 3.5 V. As to the 1 μm Li₂S@C and 500 nm Li₂S@C material, although both of them show two peaks in the first charge curves, the 500 nm Li₂S@C actually showed more capacity above 3.5 V. Since more energy is needed for the larger particles to overcome the barrier of lithium extraction, it is reasonable to conclude that the charge capacity at the higher voltage reflects bigger particle sizes. Therefore, for the 500 nm Li₂S@C material, although the primary 500 nm Li₂S spheres have the smallest particle size, this advantage was compromised because of significant agglomeration as a result of the high temperature treatment. It should also be noted that the cathodic and anodic peaks below 2.6 V are the sharpest for the 1 μm material, indicative of the highest rate of Li uptake and release. Finally, the 1 μm Li₂S@C particles with less agglomeration have the best performance among the three synthesized Li₂S@C materials. Considering all the electrochemical performance data of the three Li₂S@C composites, it can be concluded that Li₂S@C with small particle size and less agglomeration is the optimal configuration for Li/S cells.

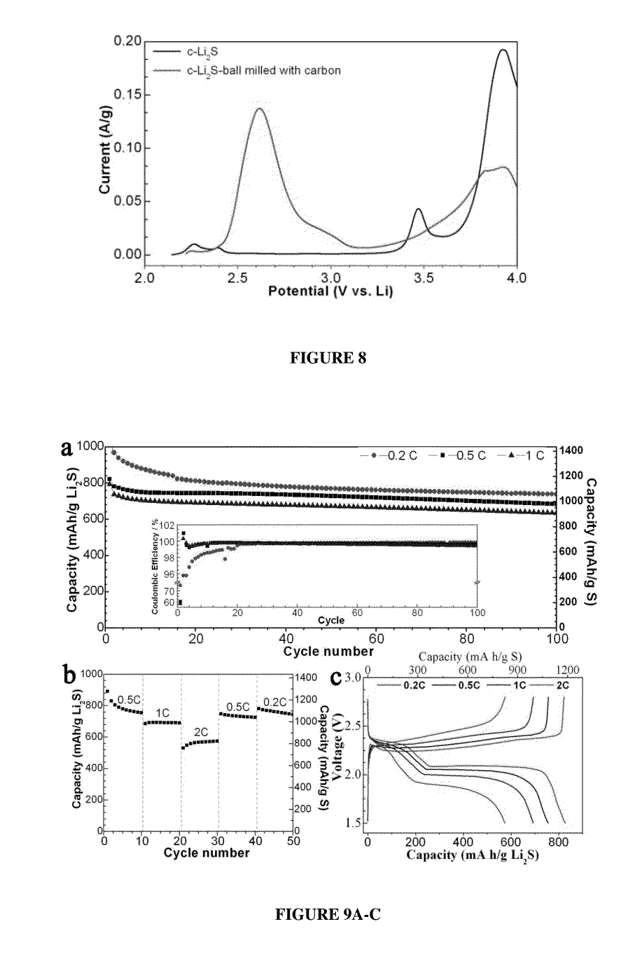

The 1 μm Li₂S@C cathodes were cycled at different C-rates (see FIG. 9A). The cells delivered good capacity retention. The initial specific capacity for the 1 μm Li₂S@C spheres cathode at the 0.2C rate is 972 mAh g⁻¹ Li₂S (1394 mAh g⁻¹ S), 821 mAh g⁻¹ Li₂S (1177 mAh g⁻¹5) at the 0.5C rate, and 793 mAh g⁻¹ Li₂S (1137 mAh g⁻¹5) at the 1C rate. After 100 cycles, the 1 μm particles can achieve a high specific capacity of 737 mAh g⁻¹ Li₂S (1056 mAh g⁻¹S) at the 0.2C rate, 683 mAh g⁻¹ Li₂S (979 mAh g⁻¹S) at 0.5C rate and 634 mAh g⁻¹ Li₂S (909 mAh g⁻¹S) at 1C rate with a Li₂S content of 60 wt % in the electrodes. The rate capability of the 1 μm Li₂S@C cathodes is shown in FIG. 9B. A highly reversible capacity of 570 mAh g⁻¹ Li₂S could still be achieved even at the 2C rate and when the C-rate was switched back to 0.5C again, the capacity recovered, indicating fast reaction kinetics in the cathodes. Representative voltage profiles of the 1 μm Li₂S@C cycled at different rates are shown in FIG. 9C. All curves show highly reversible capacities.

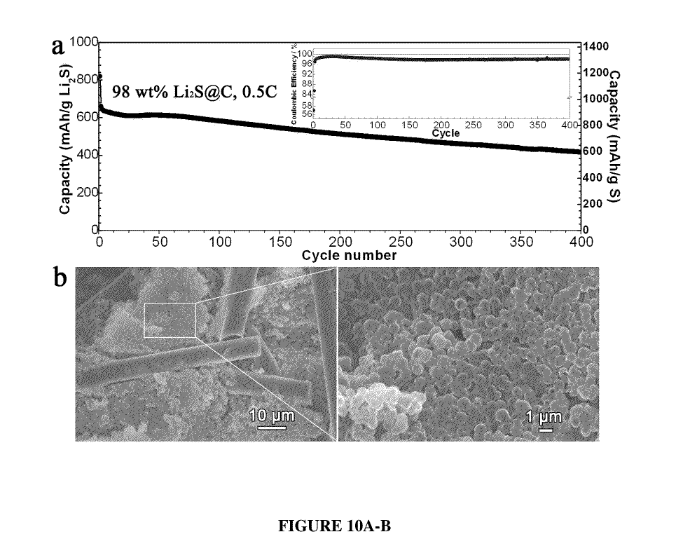

The performance of an electrode with 1 μm Li₂S@C material and a high Li₂S weight percentage, electrodes with no added carbon black was evaluated. Even though no carbon black was added, the 98 wt % Li₂S@C cells exhibited stable cycling performance with a high discharge capacity of 659 mAh g⁻¹ Li₂S (945 mAh g⁻¹ S) in the second cycle and a capacity of 417 mAh g⁻¹ Li₂S (600 mAh g⁻¹ S) after 400 cycles at 0.5C (see FIG. 10A). The 10 wt % carbon shell of the 1 μm Li₂S@C material and the current collector of carbon paper helped with the conductivity of the electrode, the core-shell particles can provide good cycling performance at a relatively high rate of 0.5C without additional carbon. After the cycling test, the electrode was removed from the cell, and the morphology of the Li₂S@C core-shell particles was examined by SEM as shown in FIG. 10B. Some broken spheres can be found in the electrode, but most of the Li₂S@C particles show little morphology change after 400 cycles which is consistent with the good cyclability of the cell. These results show that the 1 μm Li₂S@C core-shell particles are stable in the cell and are suitable materials for Li/S cells.

A number of embodiments have been described herein. Nevertheless, it will be understood that various modifications may be made without departing from the spirit and scope of this disclosure. Accordingly, other embodiments are within the scope of the following claims.

What is claimed is:

1. A method to synthesize a Li₂S core material having a uniform size, comprising:
adding a first solution comprising elemental sulfur in a nonpolar organic solvent to a second solution comprising a strong lithium based reducing agent to make a reaction mixture;
precipitating the Li₂S core material from the reaction mixture by heating the reaction mixture at an elevated temperature for 2 to 30 minutes.

2. The method of claim 1, wherein the method further comprises:
collecting the precipitated Li₂S core material from the reaction mixture;
washing the Li₂S core material; and
drying the Li₂S core material.

3. The method of claim 2, wherein the nonpolar organic solvent is selected from pentane, cyclopentane, hexane, cyclohexane, benzene, toluene, chloroform, 1,4-dioxane, tetrahydrofuran (THF), and diethyl ether.

4. The method of claim 3, wherein precipitating the Li₂S core material from the reaction mixture comprises heating the reaction mixture at an elevated temperature of between approximately 80° C. to 100° C. for 2 to 30 minutes.

5. The method of claim 4, wherein the strong lithium based reducing agent is selected from lithium triethylborohydride, n-butyl-lithium, and lithium aluminum hydride.

6. The method of claim 5 wherein the first solution comprises 64 mg of sulfur dissolved in 6 mL of the nonpolar organic solvent.

7. The method of claim 6, wherein 6 mL of the first solution is added to a second solution which comprises 1.0 M lithium triethylborohydride in 4.2 mL of tetrahydrofuran.

8. The method of claim 6, wherein 3 mL of the first solution is added to a second solution which comprises 1.0 M lithium triethylborohydride in 4.2 mL of tetrahydrofuran.

9. The method of claim 6, wherein 3.5 mL of the first solution is added to a second solution which comprises 1.0 M lithium triethylborohydride in 4.2 mL of tetrahydrofuran.

10. The method of claim 9, wherein the reaction mixture is heated at about 90° C.

11. The method of claim 10, wherein the reaction mixture is heated for 7 minutes.

12. The method of claim 10, wherein the reaction mixture is heated for 10 minutes.

13. The method of claim 12, wherein the Li₂S core material is substantially spherical in shape.

14. The method of claim 13, wherein the Li₂S core material is uniformly size particles from 500 nm to 2 μm in diameter.

15. The method of claim 14, wherein the Li₂S core material is 1 μm in diameter.

16. A uniformly sized Li₂S core material made by the method of claim 14.

17. A method of forming one or more durable and conductive carbon shells on a Li₂S core material comprising:
placing the uniformly sized Li₂S core material of claim 16 under an atmosphere comprising a carbon based precursor compound and an inert gas; and
pyrolyzing the precursor compound by heating at an elevated temperature for a period between 15 minutes to 3 hours.

18. The method of claim 17, wherein during the pyrolyzing step the Li₂S core material was periodically ground to break up any agglomerations.

19. The method of claim 18, wherein the carbon based precursor compound is selected from methane, ethylene, acetylene, benzene, xylene, carbon monoxide, or combinations thereof.

20. The method of claim 19, wherein the carbon based precursor compound is acetylene.

21. The method of claim 20, wherein the inert gas is argon.

22. The method of claim 21, wherein the inert gas to the carbon based precursor compound is introduced at a Standard Cubic Centimeters per Minute (SCCM) flow rate ratio of 1:10 to 10:1.

23. The method of claim 22, wherein the carbon based precursor compound is pyrolyzed by heating at a temperature between 400° C. to 700° C.

24. The method of claim 23, wherein carbon based precursor compound is pyrolyzed by heating at 450° C. for 1.5 hours.

25. A Li₂S core material comprising one or more carbon shells (Li₂S@C material) made by the method of claim 24.

26. An electrode comprising the Li₂S@C material of claim 25.

27. A lithium/sulfur battery comprising the electrode of claim 26.
